(19) United States
(12) Patent Application Publication
(10) Pub. No.: US 2008/0100578 A1
(43) Pub. Date: May 1, 2008

(54) Data Input Arrangement With Multi-Facet Shaped Keys

(76) Inventors: Chad Chaumont, East Setauket, NY (US); Alistair Hamilton, Stony Brook, NY (US)

Correspondence Address: FAY KAPLUN & MARCIN, LLP, 150 BROADWAY, SUITE 702, NEW YORK, NY, 10038, US

(21) Appl. No.: 11/610,594

(22) Filed: Dec. 14, 2006

Related U.S. Application Data
(60) Provisional application No. 60/863,287, filed on Oct. 27, 2006.

(51) Int. Cl. G06F 3/02

(52) U.S. Cl. 345/168

(57) ABSTRACT

A data input arrangement includes an array of input keys extending across a typing surface. At least one of the input keys includes a first viewable surface displaying a first set of input data and a second viewable surface angled relative to the first viewable surface. The second viewable surface displays a second set of input data.

### PRIORITY CLAIM

This application claims the priority to the U.S. Provisional Application Ser. No. 60/863,287, entitled “Data Input Arrangement With Multi-Facet Shaped Keys,” filed Oct. 27, 2006. The specification of the above-identified application is incorporated herewith by reference.

### FIELD OF THE INVENTION

The present invention relates generally to a data input arrangement with at least one key having a multi-facet shape. Specifically, the multi-facet shape exists on a numeric key pad incorporated in a data-centric key pad.

### BACKGROUND

Computing devices include a data input arrangement that allows a user to enter data. Conventional data input arrangements include keys with a corresponding data input. A conventional key pad such as key pad 10 of FIG. 1 may be a data-centric key pad. Specifically, the conventional key pad 10 is for a Blackberry® manufactured by Research In Motion Limited. Data-centric key pads for mobile devices are miniaturized versions of the traditional QWERTY keyboard often used for computers. Mobile devices may also include functionality to operate as a telephone. Thus, mobile devices may also include a telephonic key pad 15. However, as illustrated, due to cost and size restrictions for conventional mobile devices, the data-centric key pad will often incorporate (i.e., overlap) the telephonic key pad 15.

Conventional data-centric key pads that incorporate telephonic key pads display data to a user in the form of the types of inputs. In FIG. 1, the data-centric keys include the alphabet in the QWERTY format in addition to punctuation and symbols as a secondary data input. For example, the key “T” also includes the open parentheses (“(“). The numeric data of the telephonic key pad 15 are displayed as a second data input. Those skilled in the art will understand that conventional telephonic keys also display corresponding letters. For example, the key “7” is used for the letters “P”, “Q”, “R”, and “S”. Conventionally, to access the data input for the letters, the number key must be pushed a corresponding number of times depending on the order of the letters (e.g., pushed once for “P”, twice for “Q”, etc.). When a called party requires input from the caller in the form of corresponding letters of telephonic keys, mobile device users may have difficulty inputting the data since only numeric data is displayed. In addition, the called party is often equipped to only receive the data from the telephonic keys (i.e., cannot receive data from the data-centric keys).

### SUMMARY OF THE INVENTION

The present invention relates to a data input arrangement which includes an array of input keys extending across a typing surface. At least one of the input keys includes a first viewable surface displaying a first set of input data and a second viewable surface angled relative to the first viewable surface. The second viewable surface displays a second set of input data.

### DESCRIPTION OF THE DRAWINGS

FIG. 1 shows a conventional data input arrangement for a computing device.

FIG. 2a shows a perspective view of a multi-facet key of the data input arrangement according to an exemplary embodiment of the present invention.

FIG. 2b shows a top view of the key shown in FIG. 16a.

FIG. 2c shows a perspective view of a data input arrangement incorporating the multi-facet key of FIG. 16a.

FIG. 3 shows a perspective view for a second exemplary embodiment of a multi-facet key for the data input arrangement of FIG. 1.

FIG. 4 shows a perspective view for a third exemplary embodiment of a multi-facet key for the data input arrangement of FIG. 1.

FIG. 5 shows a perspective view for a fourth exemplary embodiment of a multi-facet key for the data input arrangement of FIG. 1.

FIG. 6 shows a perspective view for a fifth exemplary embodiment of a multi-facet key for the data input arrangement of FIG. 1.

FIG. 7 shows a perspective view for a sixth exemplary embodiment of a multi-facet key for the data input arrangement of FIG. 1.

FIG. 8 shows a perspective view for a seventh exemplary embodiment of a multi-facet key for the data input arrangement of FIG. 1.

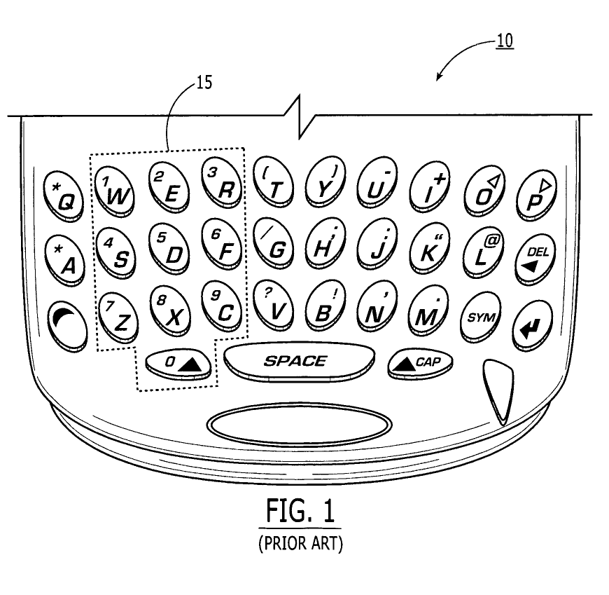

### DETAILED DESCRIPTION

The present invention may be further understood with reference to the following description and the appended drawings, wherein like elements are referred to with the same reference numerals. The present invention describes a data input arrangement for a computing device (e.g., personal computer, laptop, pager, mobile device, cell phone, radio frequency identification device, scanner, a data acquisition device, an imager, etc.). According to the exemplary embodiments of the present invention, the data input arrangement may include at least one multi-facet shaped key. The data input arrangement and the multi-facet shaped key(s) will be discussed in more detail below.

The following exemplary embodiments of the present invention describe a data input arrangement for a computing device (e.g., personal computer, laptop, pager, mobile device, cell phone, radio frequency identification device, scanner, a data acquisition device, an imager, etc.). It should be noted that the use of a mobile device is only exemplary and, as discussed above, the data input arrangement may be applied to any computing device utilizing a data input arrangement. In the following exemplary embodiments, the data input arrangement is described using a key pad disposed within a housing for a mobile device. However, the data input arrangement may be any arrangement that utilizes one or more keys to input data such as a data-centric key pad, numeric key pad, keyboard, etc. It should be noted that the use of keys is only exemplary and the data input arrangement may utilize other data input means such as switches, light sensors, heat sensors, etc.

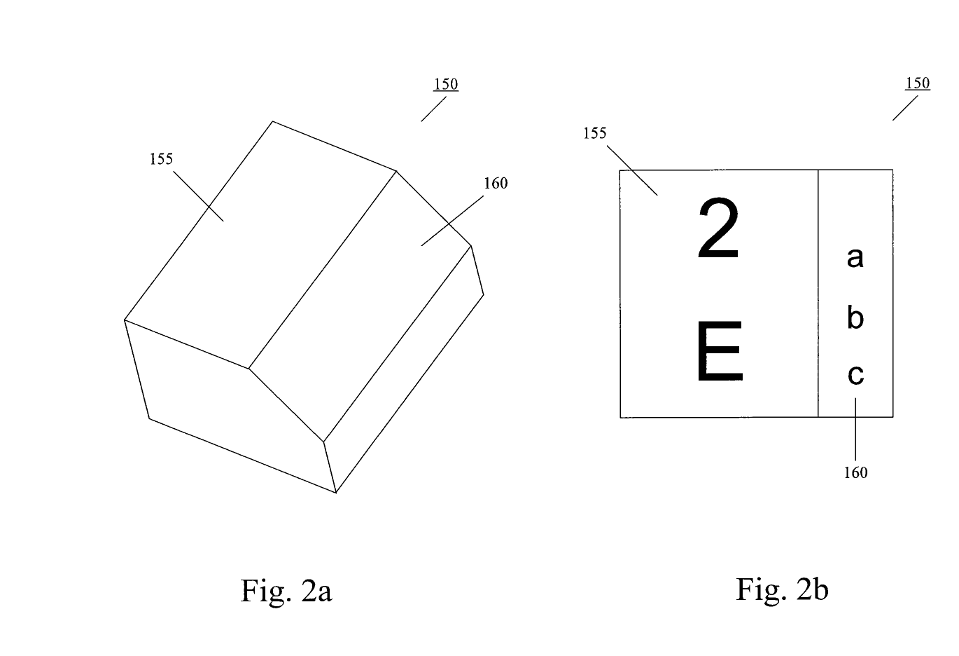

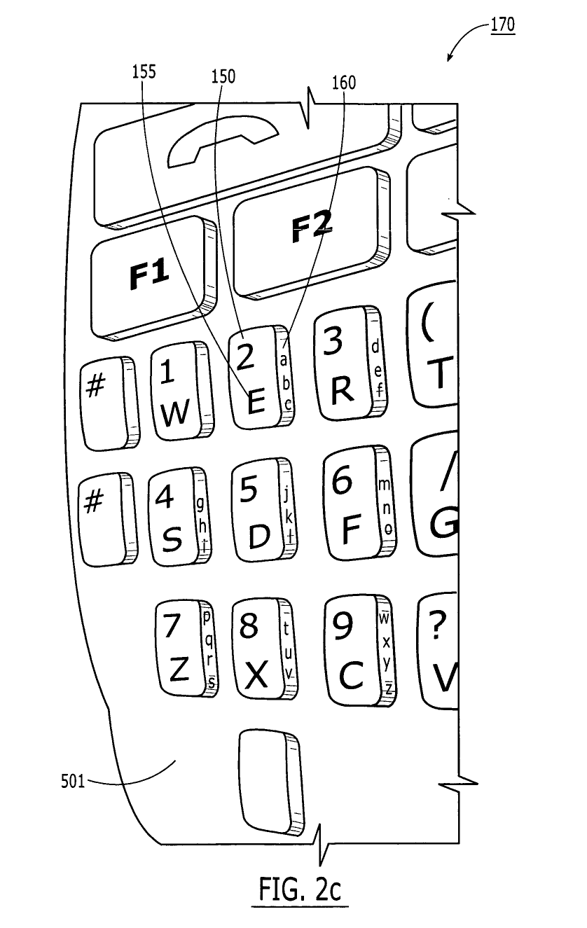

FIG. 2a shows a perspective view of a multi-facet key 150 according to an exemplary embodiment of the present invention. The multi-facet key 150 exhibits a flat surface 155 with an angled surface 160. The flat surface 155 and the angled surface 160 comprise the viewable surface of the multi-facet key 150. The angled surface 160 may exhibit an angle ranging from 10° to 45°. The area of the flat surface 155 and the area of the angled surface 160 may exhibit a ratio in a range from 2:1 to 5:1, or vice versa. It should be noted that the angle range and surface ratio is only exemplary and other ranges and/or ratios may be used. It should also be noted that the multi-facet key 150 may exhibit conventional features found on keys of a key pad such as a curvature (e.g., concavity, convexity), rounded corners, rounded edges, etc. The shape of the multi-facet key 150 applied to a data-centric key pad alleviates the problems discussed above.

FIG. 2b shows a top view of the multi-facet key 150 of FIG. 2a. As illustrated, the flat surface 155 displays the data-centric data (e.g., “E”) as a first data input and the numeric data (e.g., “2”) as the second data input. The angled surface 160 displays the corresponding letter data of the numeric data (e.g., “a”, “b”, “c”). Thus, the multi-facet key 150 displays the data-centric data, the numeric data, and the corresponding letter data. The increased surface area of the viewable surface of the multi-facet key 150 allows this additional input data to be displayed without creating a display on the key that is cluttered (e.g., no misinterpretations). The placement of the corresponding letter data on the angled surface 160 creates a sufficient separation of the data so a user easily operates the keys. It should be noted that the display of data-centric data and/or numeric data is only exemplary. The multi-facet key 150 may be used to display other types of input data such as a first language on a first surface and a second language on a second surface. This embodiment may be applied to, for example, a keyboard for a desktop computer.

FIG. 2c shows the multi-facet key 150 of FIG. 2a as part of a key pad 170 within a housing 501 according to an exemplary embodiment of the present invention. The key pad 170 is a key pad that incorporates the features of the multi-facet key 150 of FIG. 2a. In the exemplary embodiment of FIG. 2c, the features of the multi-facet key 150 are applied to the keys that display the numeric data from the telephonic keys (e.g., telephone key pad 15). Thus, when telephone functions are used on the mobile device, a key pad 170 also displays the corresponding letter data for each numeric data on the data-centric keys. It should be noted that the features of the multi-facet key 150 may be applied to all the keys of the key pad 170 to allow more input data to be displayed to a user beyond the corresponding letter input data. It should also be noted that the features of the multi-facet key 150 applied to data-centric keys is only exemplary and that the features may also be applied to non-conventional key pads (e.g., key pads not utilizing the QWERTY format). It should also be noted that the angled shape of the multi-facet key 150 is only exemplary and other shapes may be used for the multi-facet key to display different sets of data, as will be discussed below.

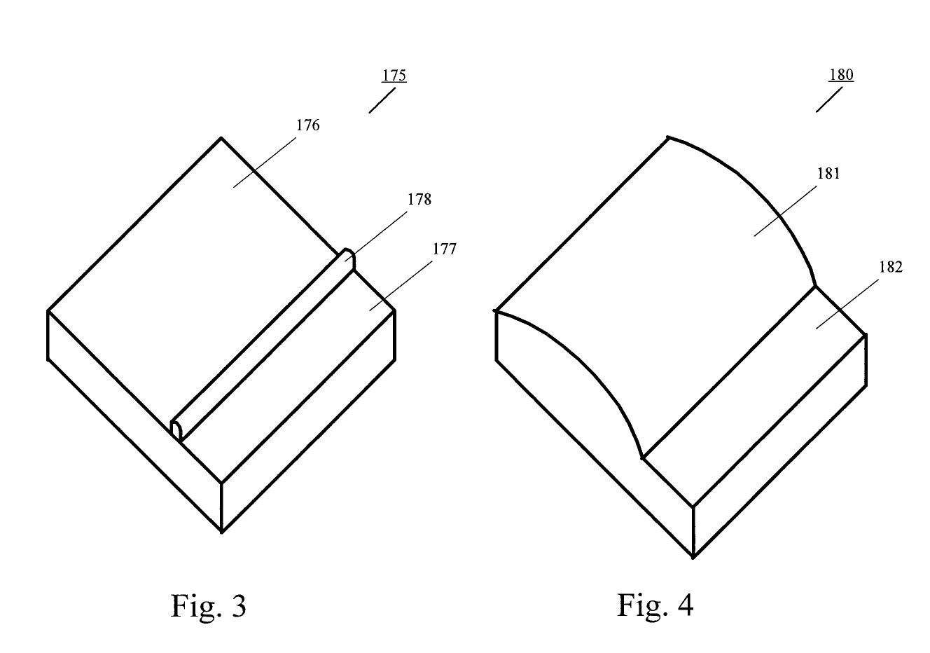

FIGS. 3-8 show further exemplary embodiments 175, 180, 185, 190, 195, 205 of the multi-facet shape of keys. The exemplary embodiment 175 as shown in FIG. 3 includes a first surface 176 and a second surface 177. The first surface 176 and the second surface 177 exist on a common plane (i.e., not angled). It should be noted that the first surface 176 and the second surface 177 may exist on parallel planes. A visible and tangible divider 178 exists between the first surface 176 and the second surface 177. The divider 178 serves to display a separation of the available data displayed on the first surface 176 and the second surface 177. Furthermore, the divider 178 is shown to be a solid, elevated surface. However, the solid, elevated surface for the divider 178 is only exemplary and the divider 178 may also be lower than the first and second surfaces, divided into multiple pieces, etc.

The exemplary embodiment 180 as shown in FIG. 4 includes a first surface 181 and a second surface 182. The first surface 181 exhibits a curved surface that is viewable by the user. The second surface 182 exhibits a linear surface. It should be noted that both surfaces may be curved. For example, the first surface 181 may be curved convexly while the second surface 182 is curved concavely. Both surfaces may exhibit the same curvature (e.g., both convex, both concave). The curved surface of the first surface 181 permits a user to distinguish the data that is displayed on the first surface 181 from the second surface 182.

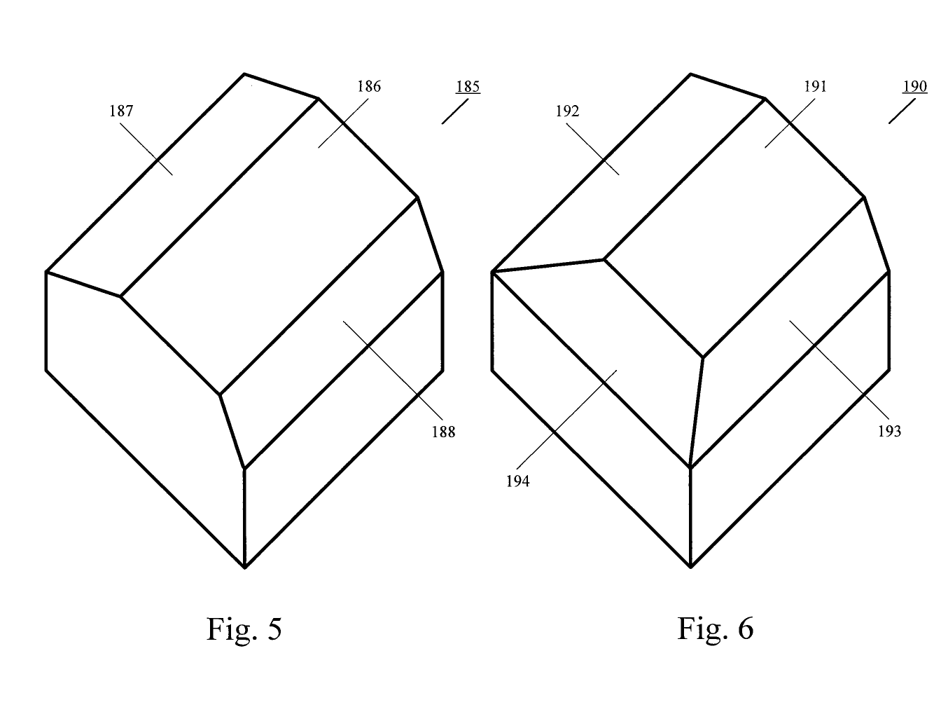

The exemplary embodiment 185 as shown in FIG. 5 includes a first surface 186, a second surface 187, and a third surface 188. The first surface 186 exhibits a linear surface. The second surface 187 and the third surface 188 are disposed on opposing sides of the first surface 186. Furthermore, the second surface 187 and third surface 188 exist on an angled surface with respect to the first surface 186. The third surface 188 further allows more data to be displayed on the viewable surface area of the multi-facet key in the exemplary embodiment 185.

The exemplary embodiment 190 as shown in FIG. 6 includes a first surface 191, a second surface 192, a third surface 193, and a fourth surface 194. The first surface 191 exhibits a linear surface. The second surface 192 and the third surface 193 are disposed on opposing sides of the first surface 191. The fourth surface 194 is disposed on another side of the first surface 191. Furthermore, the second surface 192, the third surface 193, and the fourth surface 194 exist on an angled surface with respect to the first surface 191. The fourth surface 194 further allows more data to be displayed on the viewable surface area of the multi-facet key in the exemplary embodiment 190.

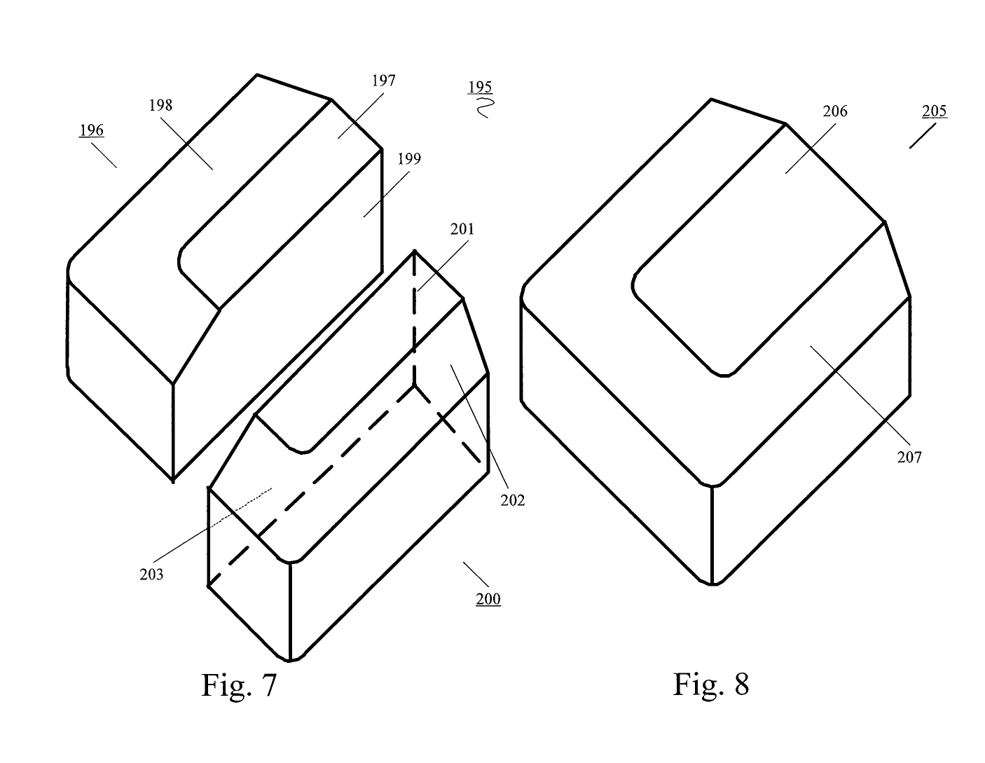

The exemplary embodiment 195 as shown in FIG. 7 includes two keys 196, 200. The first key 196 includes a viewable surface comprising a first surface 197 and a second surface 198. A first vertical surface 199 is included that spans across the raised side of the key 196. The second key 200 includes a viewable surface comprising a third surface 201 and a fourth surface 202. A second vertical surface 203 is included that spans across the raised side of the key 200. The keys 196, 200 may be disposed in close proximity where the vertical surfaces 199, 203 are facing each other. It should be noted that the keys 196, 200 exhibit rounded corners. The substantial ell shape created with the different elevations (e.g., surface 198, 202) allows the exemplary embodiment 195 to display data to the user along the edge of the viewable surface for both the keys 196, 200.

The exemplary embodiment 205 as shown in FIG. 8 includes a first surface 206 and a second surface 207. The exemplary embodiment 205 also includes rounded corners. The substantial U-shape (e.g., surface 207) created with the different elevations allows the exemplary embodiment 205 to display data to the user along the edge of the viewable surface.

It should be noted that the above described embodiments are only exemplary and that other embodiments exist for the multi-facet shape of keys. Furthermore, the use of angles or dividers is only exemplary and other embodiments exist to display multiple sets of data on the surface of a key. For example, the keys may include a single viewable surface using colors to distinguish the different sets of input data. Using the example of data-centric keys and numeric keys, the data-centric input data may be on a black background with white lettering while the numeric input data may be on a yellow background with blue lettering. The color scheme may also be used in combination with the above described embodiments. The angles of the above described embodiments may also be in an opposite direction. That is, the exemplary embodiments illustrate a decreasing angle with respect to the flat surface (e.g., surface 160 with respect to surface 155 of FIG. 2a). However, this decreasing angle is only exemplary and the angled surface may be on an increasing angle with respect to the flat surface.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A data input arrangement, comprising:
an array of input keys extending across a typing surface, at least one of the input keys including a first viewable surface displaying a first set of input data and a second viewable surface angled relative to the first viewable surface, the second viewable surface displaying a second set of input data.

2. The data input arrangement of claim 1, wherein the at least one of the input keys includes a third viewable surface angled relative to the first surface displaying a third set of input data.

3. The data input arrangement of claim 1, wherein at least one of the first viewable surface and the second viewable surface exhibits a curvature.

4. The data input arrangement of claim 1, wherein the first and second viewable surfaces extend at least partially a length of the input key.

5. The data input arrangement of claim 1, wherein the first viewable surface has a first color and the second viewable surface has a second color different from the first color.

6. The data input arrangement of claim 1, wherein the second viewable surface is a decreasing angle relative to the first viewable surface.

7. The data input arrangement of claim 1, wherein the second viewable surface is an increasing angle relative to the first viewable surface.

8. The data input arrangement of claim 1, wherein a computing device includes the data input arrangement.

9. The data input arrangement of claim 8, wherein the computing device is one of a personal computer, a laptop computer, a mobile device, a pager, a cell phone, an imaging scanner, a laser scanner, a data acquisition device, a radio frequency identification reader, a barcode reader, and a wearable device.

10. A mobile device, comprising:
a housing; and
a data input arrangement at least partially disposed within at least a portion of the housing, the data input arrangement including an array of input keys extending across a typing surface, at least one of the input keys including a first viewable surface displaying a first set of input data and a second viewable surface angled relative to the first viewable surface, the second viewable surface displaying a second set of input data.

11. The mobile device of claim 10, wherein the at least one of the input keys includes a third viewable surface angled relative to the first surface displaying a third set of input data.

12. The mobile device of claim 10, wherein at least one of the first viewable surface and the second viewable surface exhibits a curvature.

13. The mobile device of claim 10, wherein the first and second viewable surfaces extend at least partially a length of the input key.

14. The mobile device of claim 10, wherein the first viewable surface has a first color and the second viewable surface has a second color different from the first color.

15. The mobile device of claim 10, wherein the second viewable surface is a decreasing angle relative to the first viewable surface.

16. The mobile device of claim 10, wherein the second viewable surface is an increasing angle relative to the first viewable surface.

17. The mobile device of claim 10, wherein the at least one input key including the second viewable surface is grouped separately.

18. The mobile device of claim 10, wherein the at least one input key including the second viewable surface is grouped within the array of input keys.

19. A data input arrangement, comprising:
an array of input keys extending across a typing surface, at least one of the input keys including a first viewable surface displaying a first set of input data and a second viewable surface displaying a second set of input data, the second viewable surface separated from the first viewable surface by a tactile divider.

20. A data input arrangement, comprising:
a first array of input keys extending across a typing surface, the first array of input keys including a single surface displaying part of a first set of input data; and
a second array of input keys extending across the typing surface, the second array of input keys including a first surface displaying a remainder of the first set of input data and a second surface angled relative to the first surface displaying a second set of input data.

21. A data input key, comprising:
a housing having a first viewable surface and a second viewable surface, the first viewable surface displaying a first input datum and the second viewable surface angled relative to the first viewable surface displaying a second input datum.
